(19) United States
(12) Patent Application Publication
(10) Pub. No.: US 2004/0158606 A1
(43) Pub. Date: Aug. 12, 2004

(54) TRANSMISSION METHOD OF MULTIMEDIA DATA OVER A NETWORK

(76) Inventor: Mingtar Tsai, Cupertino, CA (US)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/249,435

(22) Filed: Apr. 8, 2003

Related U.S. Application Data
(60) Provisional application No. 60/446,091, filed on Feb. 10, 2003.

(51) Int. Cl. G06F 15/16

(52) U.S. Cl. 709/203

(57) ABSTRACT

A system and method to allow multimedia (voice and video) data communication to pass through enterprise firewalls and proxy, which include network address translator (NAT). The system also includes servers to redirect voice/video data packets to other VoIP standard conforming servers. The redirect server sends command and data either using transmission control protocol (TCP) or user datagram protocol (UDP), depending on the configuration and protocol requirements of each server. This method is compatible with the existing communication standards, such as ITU H.323, session initiation protocol (SIP), media gateway control protocol (MGCP) and media gateway control (MEGACO).

### CROSS REFERENCE TO RELATED APPLICATIONS

This application claims the priority benefit of a provisional application serial No. 60/440,091, filed Jan. 16, 2003, titled “Multimedia (voice and video) data communicate through firewall or proxy under Intranet or Internet”. All disclosures are incorporated herewith.

### BACKGROUND OF INVENTION

1. Field of the Invention

This invention relates to a transmission method for multimedia data communications over a network. More particularly, the present invention relates to a transmission method and system to enable voice and video data communication through network filters such as enterprise firewalls or proxy servers applicable to Intranets or the Internet without the need of reconfiguring existing firewall or proxy nor opening special ports.

2. Related Art of the Invention

Voice/video over Internet Protocol (VoIP) is a vital application over the internet and intranets. Most of the major telecommunication carriers are ready for the mass deployment of VoIP services. However, as VoIP traffic are communicated over the internet and intranets, VoIP commands and data cannot pass through network filters, for example, firewall and proxy, without having to open special ports. Opening such special ports endangers the security of the entire network using VoIP as hackers are able to utilize the portals in the filter to hack into protected networks. Therefore, it is necessary to develop VoIP applications which do not require the opening of special ports during voice and video data communications.

### SUMMARY OF INVENTION

The present invention is to provide a method and system enabling the tranmission of multimedia data via redirect servers, which communicate with endpoints in the network through regular network filter such as an enterprise firewall, a network address translator, or a proxy. The application of the present invention requires no configuration changes within the network filter.

The present invention supports both endpoints having private internet protocol (IP) addresses and/or endpoints located inside proxy servers.

The present invention will also support having one endpoint inside a firewall and the other endpoint having a public IP address. In addition, communication between an endpoint with a private IP address and the other endpoint having a public IP address is also supported by the present invention. Endpoints to be Internet Protocol (IP) phone or softphone.

The present invention supports endpoint using transmission control protocol (TCP) or user datagram protocol (UDP) for transmitting command and voice/video data.

The present invention supports multimedia data- voice and video-communications between endpoints ultilizing any of the existing communication protocols, such as H.323 (a standard approved by the International Telecommunication Union, reference ITU-T H.323), session initiation protocol (SIP, reference IETF RFC 2543), media gateway control protocol (MGCP, reference IETF RFC 2705), and media gateway control (MEGACO, reference ITU-T H.248).

The present invention supports multimedia data and voice communication through network filters using redirect servers.

### BRIEF DESCRIPTION OF DRAWINGS

These, as well as other features of the present invention, will become apparent upon reference to the drawings wherein:

FIG. 1 is a block diagram depicting one method of the VoIP data transmission through network filters with a redirect signal server according to a preferred embodiment of the present invention.

FIG. 2 is a block diagram depicting one method of the VoIP data transmission through a firewall and a network address translator (NAT) with a redirect signal server according to a preferred embodiment of the present invention. This is a special case of FIG. 1

FIG. 3 is a block diagram depicting one method of the VoIP data transmission through a firewall and a proxy with a redirect signal server according to a preferred embodiment of the present invention. This is a special case of FIG. 1

FIG. 4 is a block diagram depicting one method of the VoIP data transmission through network filters with a redirect media server according to a preferred embodiment of the present invention.

FIG. 5 is a block diagram depicting one method of the VoIP data transmission through a firewall and a NAT with a redirect media server according to a preferred embodiment of the present invention. This is a special case of FIG. 4.

FIG. 6 is a block diagram depicting one method of the VoIP data transmission through network filters with a redirect server according to the present invention.

FIG. 7 is a printout displaying the format of real-time transport protocol (RTP) with header extensions according to the present invention.

FIG. 8 is a block diagram depicting the transmission of command and data between the redirect server, signal server and media server according to a preferred embodiment of the present invention.

FIG. 9 is a block diagram depicting one method of the VoIP data transmission through network filters with redirect servers located on both sides of the network filters according to a preferred embodiment of the present invention.

FIG. 10 is a printout displaying the extension format to RTP header according to a preferred embodiment of the present invention.

### DETAILED DESCRIPTION

FIG. 1 depicts the exchange of commands and response to commands in the communication between two endpoints of a network, endpoint 30 and endpoint 40 using redirect signal server 25 according to a preferred embodiment of the invention. Command is sent from the endpoints, 30 and 40, to the redirect signal server 25 using the transmission control protocol (TCP) or other standard data transmission protocols over networks.

While making the connection, commands are sent from endpoints 30 and 40 to the redirect signal server 25 through respective network filters 50 and 60 of endpoints 30 and 40. The redirect signal server 25 saves information relating to each endpoint, e.g. IP addresses and port numbers of the endpoints. The redirect signal server 25 then sends the commands to a signal server 70 using a protocol supported by 70, for example, UDP. Signal server 70 can be one of the many standard servers such as H.323 Gatekeeper (a standard approved by the International Telecommunication Union, reference ITU-T H.323, which can be easily obtained in the internet, for example, the website http://www.itu.int), session initiation protocol Proxy server (SIP, reference IETF RFC 2543, which can be easily obtained in the internet, for example, the website link http://www.ietf.org), media gateway control protocol callagent server (MGCP, reference IETF RFC 2705, which can be easily obtained in the internet, for example, the website link http://www.ietf.org), and media gateway control callagent server (MEGACO, reference ITU-T H.248, which can be easily obtained in the internet, for example, the website link http://www.ietf.org). A response is then sent back to the redirect signal server 25 by the signal server 70 and is subsequently relayed back to the endpoints, 30 and 40, by the redirect signal server 25.

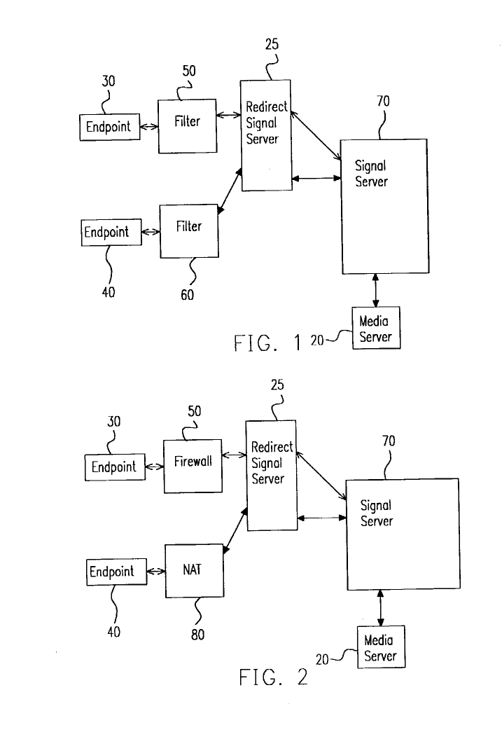

For exemplary purposes, FIG. 2 depicts one endpoint, endpoint 30, as being within an enterprise firewall, firewall 50, while endpoint 40 is within a network address translator (NAT), NAT 80. The redirect signal server 25 can send commands using UDP or TCP, such as SIP INVITE, to a session initiation protocol (SIP) proxy server acting as signal server 70, without modifying the private IP address and port number (of endpoints 30 and 40) as long as the media server 20 can handle the NAT 80 and Firewall 50 directly. This reduces the overhead of the redirect signal server 25. The media server 20 saves the endpoint ID, IP address and the user datagram protocol (UDP) port number of the endpoint in order to communicate with endpoints. This allows the media server 20 to know which endpoint the data is coming from based on the port number that it receives voice/video packet data. Media server 20 can be software based or VoIP compliant telephony gateway. A gateway is a device that translates VoIP signals into signals that can be understood by traditional phone system.

The signal server 70, for this example a SIP proxy server, will send commands, such as SIP INVITE, to the SIP media server 20 to open real-time transport protocol (RTP) ports to receive voice/video data. The signal server 70 communicates with the media server 20 using RTP. The media server 20 sends response with its public IP address and port numbers to the redirect signal server 25 that subsequently sends response back to endpoints, 30 and 40, via TCP connection. Thus, the endpoint will have specific remote IP address and port number to send the multimedia data to the destination endpoint.

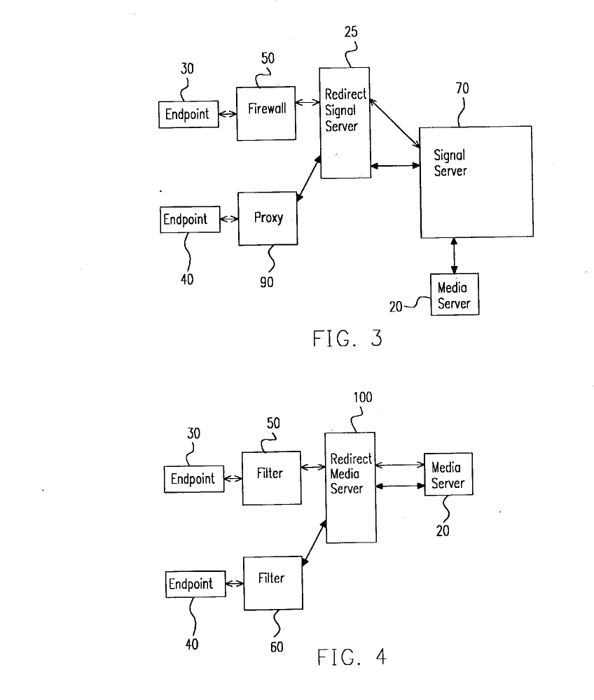

FIG. 3 shows one variant of the network filter embodiment discussed above with a proxy server, proxy 90.

Depicted in FIG. 4, the endpoints, 30 and 40, connect to a redirect media server 1 00 via a TCP protocol or other standards in data transmission control over networks. Using the information (IP address and port numbers) from the media server 20, endpoints 30 and 40 send multimedia data to the redirect media server 100 through the network filters, filter 50 and filter 60. The redirect media server 100 then sends data to the media server 20 through UDP. The format of the data sent by the endpoints, 30 and 40, is the same as recommended by IETF RFC 1 889 (RTP).

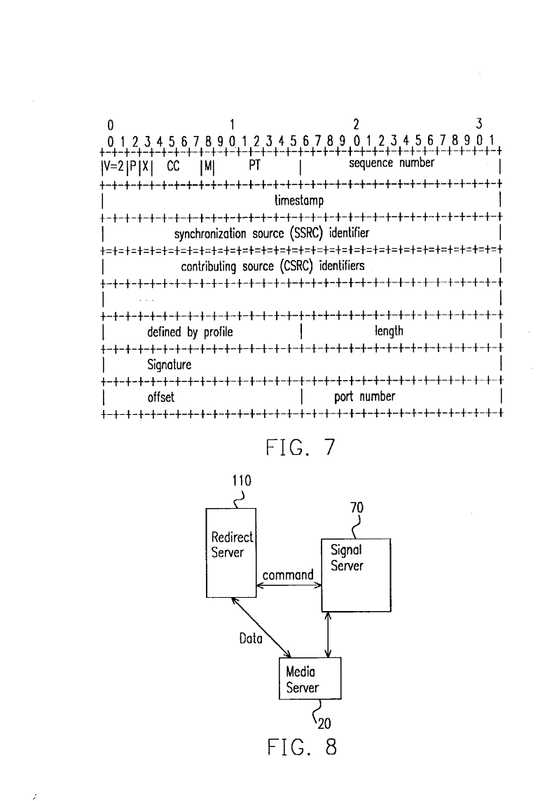

The endpoints, 30 and 40, add a RTP profile-specific extension as illustrated in FIG. 7 into the RTP header. Information included in the RTP extension are for example, remote port number, offsets, and signatures. From the RTP extension, the redirect media server 100 will then know how to send data to the media server 20. The signature, such as “HTTM”, is 32-bit in length. Although each data packet size may vary, the redirect media server 100 can find each data packet by searching the signature within the RTP profile-specific extension. Once the signature is located, the offset which is the number of bytes to the beginning of the data packet can then be determined. The port number is the media server 20 UDP port number for receiving a specific data packet.

The RTP header extension can be variant in format during implementation, such as type of parameters included, parameter bit-length, ordering of parameters and the total size of RTP extension. For example, the signature can be omitted, in different size or in different location within the extension.

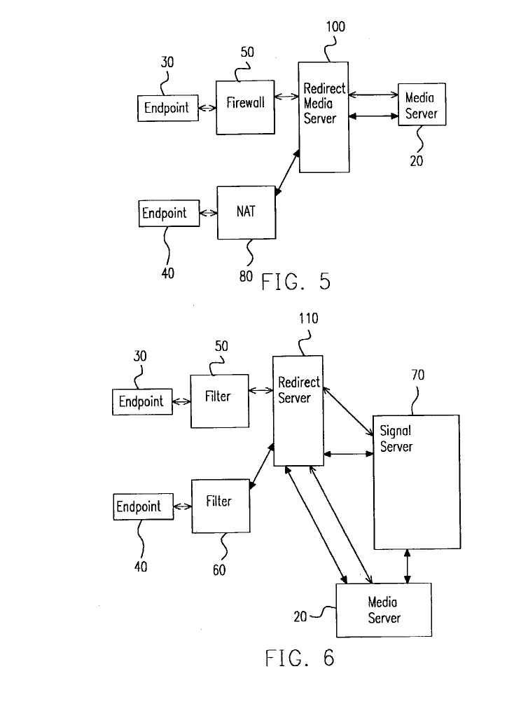

FIG. 5 is a variant of the embodiment shown in FIG. 4 with a NAT 80 in place of the filter 60.

FIGS. 6 and 8 illustrate the endpoint 30 and endpoint 40 connects to a redirect server 10 via TCP. In accordance to the present invention, the endpoints 30 and 40 send command and multimedia data to the same redirect server 110 as applied to the transfer of commands to the redirect signal server 25 and the transfer of multimedia data to the redirect media server 100, previously mentioned. When the endpoints 30 and 40 send command or multimedia data to the redirect server 110, a RTP header extension (shown in FIG. 10) is added to mark the transmitted data as command or multimedia data. The signature, such as “HTTM”, is 32-bit in length. The length is the total data packet size. Port number refers to the media server 20 UDP port number used to receive voice/video data. Data type is either command or voice/video. When the redirect server 110 receives data, it first finds the entire data packet. Then the redirect server 110 will check for the data type. If the data type is command, it sends the data to the signal server 70. If the data type is voice/video, the redirect server 110 sends the data to the media server 20 with the port number stored in the header. The RTP header extension can be variant in format during implementation, such as type of parameters included, parameter bit-length, ordering of parameters and the total size of RTP extension. For example, the signature can be omitted, in different size or in different location within the extension.

This second method of the present invention incorporates the function of both the redirect signal server 25, which is shown in FIGS. 1-3, and the redirect media server 100, which is shown in FIGS. 4-5, into a single redirect server 110. As shown in FIG. 8, the redirect server 110 sends the commands to the signal server 70 and sends the multimedia data to the media server 20.

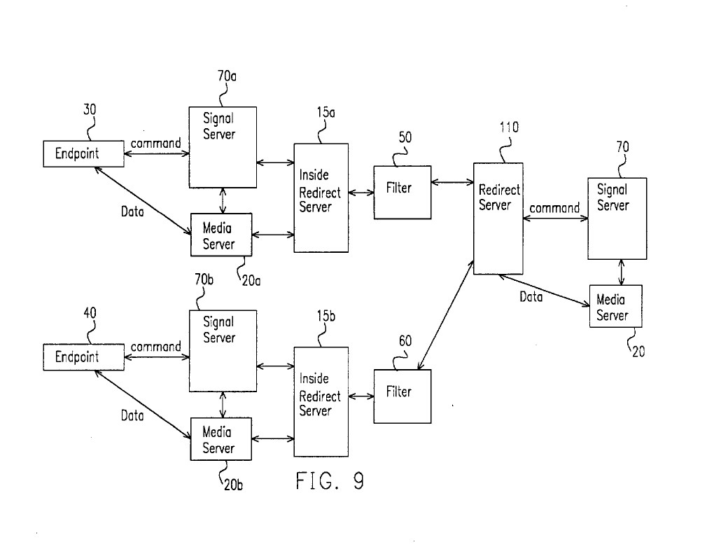

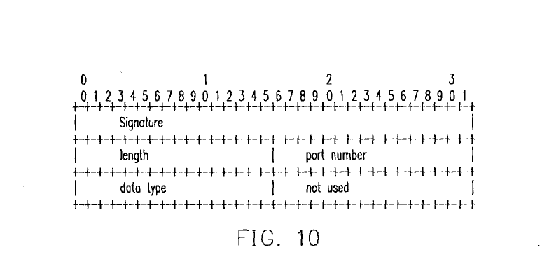

Another preferred embodiment of the present invention is shown in FIG. 9. Inserted between the endpoint 30 and endpoint 40, and respective network filters of the endpoints 30 and 40, a filter 50 and a filter 60, is a signal server, 70a and 70b, a media server 20a and 20b, and an inside redirect server, 15a and 1 5b. Outside of the filters 50 and 60, there is another redirect server 110 or a combination of signal redirect server and media redirect server as mentioned previously, that controls data transmission between the two nodes of the network.

In this embodiment the endpoints, 30 and 40, send commands and multimedia data using TCP or UDP. The command sent by the original endpoint includes voice/video data and the private or public IP address, port number, and identification of the destination endpoint.

For exemplary purposes, it is assumed that the endpoint 30 is an original node, while the endpoint 40 is a destination node. The endpoint 30 sends a command to a signal server 70a, which conforms to one of the SIP, H.323, MGCP, or MEGACO standards. The command includes a private or a public IP address, a voice/video port number of endpoint 30 and an identification of the destination endpoint 40. Upon receiving the data, the signal server 70a sends a command to the media server 20a, which sends a response with its own public IP address and port number back to the signal server 70a. The signal server 70a sends this information back to the endpoint 30. Upon the completion of the data exchange, the signal server 70a sends the command to the media server 20a to create a corresponding endpoint M1 used to communicate with the desired destination endpoint 40. This also applies to FIG. 1, 2 and 3.

After the connection to an endpoint M1 has been established, the signal server 70a will send the command along with the information of the endpoint M1 to an inside redirect server 15a. The inside redirect server 15a then adds a header extension to the command as described in FIG. 10 and sends the revised command to an outside redirect server 110 through the network filter, such as a filter 50, using the TCP or any protocol allowed by the network filter security protocol.

The media server 20a receives the multimedia data, such as voice or video, from the endpoint 30 and forward the data to the inside redirect server 15a. The inside redirect server 15a adds the header extension to the multimedia data as described in FIG. 10 and sends the data to the redirect server 110 through the filter 50 using TCP or any protocol allowed by the network filter security protocol.

Upon receiving the data from redirect server 15a, the redirect server 110 locates the data packet and checks the data type. If the data is command, the redirect server 110 sends the command to the signal server 70. If the data is multimedia, voice or video, the redirect server 110 sends the data to the media server 20.

The signal server 70 sends the received command back to the redirect server 110 with the information of destination node endpoint 40. The redirect server will add the header extension to the command as described in FIG. 10 and forward the newly formatted command to the redirect server 15b through the network filter, filter 60. The inside redirect server 15b will parse and remove the header extension and send the command to the signal server 70b. The signal server 70b then sends this information to endpoint 40.

Upon the completion of the transmission of command, the endpoint 30 is now able to exchange multimedia, voice and video, data with the endpoint 40 through the following points: media server 20a, inside redirect server 15a, filter 50, redirect server 110, media server 20, redirect server 110, filter 60, redirect server 15b, media server 20b.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A transmission method for multimedia data through a network, the method comprising:
a first endpoint sending a first command to a redirect server through a first network filter with a first data transmission protocol, wherein the redirect server obtains information of the first endpoint and saves the information therein;
the redirect server sending the first command to a server and receiving a first in response to the first command from the server;
the redirect server sending the first response to the first endpoint, thereby the transmission for multimedia data through the first endpoint and the server is established there.

2. The transmission method of multimedia data according to claim 1, wherein the redirect server is a redirect signal server.

3. The transmission method of multimedia data according to claim 1, wherein the redirect server is a redirect media server.

4. The transmission method of multimedia data according to claim 1, wherein server includes a signal server.

5. The transmission method of multimedia data according to claim 4, wherein the signal server is a H.323 Gatekeeper.

6. The transmission method of multimedia data according to claim 4, wherein the signal server is a session initiation protocol (SIP) Proxy server.

7. The transmission method of multimedia data according to claim 4, wherein the signal server is a media gateway control protocol (MGCP) callagent server.

8. The transmission method of multimedia data according to claim 4, wherein the signal server is media gateway control (MEGACO) callagent server.

9. The transmission method of multimedia data according to claim 4, wherein the server further includes a media server.

10. The transmission method of multimedia data according to claim 9, wherein the media server is a software-based telephony gateway.

11. The transmission method of multimedia data according to claim 9, wherein the media server is a voice/video over internet protocol (VoIP) compliant telephony gateway, wherein the VoIP compliant telephony gateway is a device for translating VoIP signals into signals that can be understood by a phone system.

12. The transmission method of multimedia data according to claim 9, wherein a real-time transport protocol (RTP) is being supported in the communication between the signal server and the media server.

13. The transmission method of multimedia data according to claim 1, wherein the first data transmission protocol is a transmission control protocol (TCP).

14. The transmission method of multimedia data according to claim 1, wherein the multimedia data is voice or video data.

15. The transmission method of multimedia data according to claim 1, wherein the first network filter is an enterprise firewall.

16. The transmission method of multimedia data according to claim 1, wherein the first network filter is a network address translator (NAT).

17. The transmission method of multimedia data according to claim 1, wherein the first network filter is a proxy server.

18. The transmission method of multimedia data according to claim 1, further comprising:
a second endpoint sending a second command to the redirect server through a second network filter with a second data transmission protocol, wherein the redirect server obtains information of the second endpoint and saves the information therein;
the redirect server sending the second command to the server and receiving a second response to the second command from the server;
the redirect server sending the second response to the second endpoint, thereby the transmission for multimedia data through the second endpoint and the server is established there.

19. The transmission method of multimedia data according to claim 18, wherein the multimedia data is transferred between the first endpoint and the second endpoint, the redirect server, and the server according to the saved information of the first endpoint and the second endpoint, without having to reconfigure the first network and the second network filters nor requiring the opening of a special port for the transmission.

20. The transmission method of multimedia data according to claim 1 9, wherein a real-time transport protocol (RTP) is being supported in the server.

21. The transmission method of multimedia data according to claim 19, wherein the multimedia data transferred between the first endpoint and the second endpoint, the redirect server, and the server transmission protocol is TCP.

22. The transmission method of multimedia data according to claim 19, wherein the multimedia data transferred between the first endpoint and the second endpoint, the redirect server, and the server transmission protocol is a user datagram protocol (UDP).

23. The transmission method of multimedia data according to claim 1, wherein the information of the first endpoint is an IP address and a port number of the first endpoint.

24. The transmission method of multimedia data according to claim 1, wherein the IP address is a public IP address or a private IP address.

25. A transmission method for multimedia data through a network, the method comprising:
a first endpoint sending a command to an inside redirect server through a first signal server via a data transmission protocol;
the inside redirect server forwarding the command to a second redirect server via a first network filter;
the second redirect server sending the command to a second signal server for processing and receiving the processed command from the second signal server;
the second redirect server sending the processed command to a third redirect server via a second network filter;
the third redirect server sending the processed command to a third signal server;
the third signal server sending the command to a second endpoint;
the first endpoint sending multimedia data to a first media server via a standard multimedia data transmission protocol;
the first media server sending the multimedia data to the first redirect server;
the first redirect server sending the multimedia data to the second redirect server via the first network filter;
the second redirect server sending the multimedia data to a second media server for processing;
the second media server returning the processed multimedia data to the second redirect server;
the second redirect server sending the processed multimedia data to the third redirect server via the first network filter;
the third redirect server sending the processed multimedia data to a third media server; and
the third media server sending the processed multimedia data to the second endpoint, thereby the transmission for multimedia data through the second endpoint and the server is established there.

26. The transmission method of multimedia data according to claim 18, wherein the multimedia data is transferred between the first endpoint and the second endpoint, the redirect server, and the server according to the saved information of the first endpoint and the second endpoint, without having to reconfigure the first network and the second network filters nor requiring the opening of a special port for the transmission.

27. A system for transmitting multimedia data between a endpoint and a network server through a redirect server, the system comprising:
a first transmission path, for the endpoint to send a first command to the redirect server through a first network filter with a first data transmission protocol, wherein the redirect server obtains information of the first endpoint and saves the information therein;
a second transmission path, for the redirect server to send the command to the network server and receiving a first response to the first command from the network server; and
a multimedia data transmission path, being established when the redirect server sending the first response to the first endpoint, thereby the multimedia data transmission path allows the transmission for multimedia data through the first endpoint and the network server.

28. The system of claim 27, wherein the redirect server is a redirect signal server.

29. The system of claim 27, wherein the redirect server is a redirect media server.

30. The system of claim 27, wherein the network server includes a signal server.

31. The system of claim 27, wherein the signal server is a H.323 Gatekeeper, a session initiation protocol (SIP) Proxy server, a media gateway control protocol (MGCP) callagent server, or a media gateway control (MEGACO) callagent server.

32. The system of claim 30, wherein the server further includes a media server.

33. The system of claim 32, wherein the media server is a software-based telephony gateway.

34. The system of claim 32, wherein the media server is a voice/video over internet protocol (VoIP) compliant telephony gateway, wherein the VoIP compliant telephony gateway is a device for translating VoIP signals into signals that can be understood by a phone system.

35. The system of claim 32, wherein a real-time transport protocol (RTP) is being supported in the communication between the endpoint and the media server.
